(19) United States
(12) Patent Application Publication
(10) Pub. No.: US 2008/0054153 A1
(43) Pub. Date: Mar. 6, 2008

(54) Microphone Holder

(75) Inventors: Gerd Soehnholz, Essel (DE); Dieter Fleischer, Hannover (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Sennheiser Electronic GmbH & Co., KG

(21) Appl. No.: 11/661,708

(22) PCT Filed: Aug. 31, 2005
(86) PCT No.: PCT/EP05/54273

§ 371 Date: Aug. 1, 2007

(30) Foreign Application Priority Data
Sep. 1, 2004 (DE) 20 2004 013 741.0

(51) Int. Cl. F16M 13/02; H04R 1/08

(52) U.S. Cl. 248/645

(57) ABSTRACT

The invention concerns a microphone holder for fixing at least one microphone and a microphone with microphone holder. The object of the present invention is to provide a microphone holder which ensures a greater degree of flexibility in terms of the adjustability and positionability of a microphone with respect to the acoustic source. A microphone holder for fixing at least one microphone comprising a holding portion having a holding device for holding a microphone, and a clamping portion for fixing the microphone holder, wherein the holding portion has an adjusting device for adjusting the holding device along the holding portion, wherein the holding portion is of a substantially arcuate configuration.

### CROSS-REFERENCE TO RELATED APPLICATIONS

This application claims priority of International Application No. PCT/EP2005/054273, filed Aug. 31, 2005 and German Application No. 20 2004 013 741.0, filed Sep. 1, 2004, the complete disclosures of which are hereby incorporated by reference.

### BACKGROUND OF THE INVENTION

a) Field of the Invention

The invention concerns a microphone holder for fixing at least one microphone and a microphone with microphone holder.

b) Description of the Related Art

DE 295 18 362 discloses a microphone holder for fixing a microphone to a drum of a percussion instrument. The microphone holder has a holding portion for holding the microphone and a fixing portion for fixing the microphone holder to a drum. The fixing portion is in the form of a clamping element for fixing to a tensioning hoop of a drum and is substantially of an elastic material and has a hook-like curved first part and a second part with at least one groove directed towards the first part. The fixing portion is thus in the form of a clamp. Provided on the holding portion are adjusting means for adjusting the portion between the microphone and the drum. Provided in the holding portion is a slot which by means of a clamping screw serves for adjusting the microphone or the spacing thereof with respect to the drum.

A microphone holder of that kind is in need of improvement however in terms of adjustability and positionability of the microphone in relation to the acoustic source such as for example the drum.

### OBJECT AND SUMMARY OF THE INVENTION

Accordingly the primary object of the present invention is to provide a microphone holder which ensures a greater degree of flexibility in terms of adjustability and positionability of a microphone in relation to the acoustic source.

That object is attained by a microphone holder, in accordance with the invention, for fixing at least one microphone housing comprising a holding portion having a holding means for holding a microphone and a clamping portion including adjusting means for adjusting the holding means along the holding portion. The holding portion includes adjusting means for adjusting the holding means along the holding portion. The holding portion is of a substantially arcuate configuration. The adjusting means is in the form of a screw connection for clamping the microphone fast in the adjusting means and for securing the adjusting means to the arcuate holding portion. Also in accordance with the invention, the object is attained by a microphone having a microphone holder as just described wherein the microphone is in the form of a swan-neck microphone.

Accordingly there is provided a microphone holder for fixing at least one microphone having a holding portion and a clamping portion. The holding portion has holding means for holding a microphone. The clamping portion serves for fixing the microphone holder. The holding portion has adjusting means for adjusting the holding means along the holding portion. In that case the holding portion is substantially in the form of a circular arc.

The adjustability and the positionability of a microphone can be improved by the arcuate holding portion.

In accordance with an aspect of the invention a screw connection serves for fixing the microphone in the adjusting means and for securing the adjusting means to the arcuate holding portion. In that way, by means of a single screw connection, both the microphone is fixed and also adjustment along the arcuate holding portion is made possible.

In accordance with a further aspect of the present invention the arcuate holding portion has a slot.

In accordance with a further aspect of the present invention the arcuate holding portion has a latching configuration at least in portion-wise manner. Arrestability along the holding portion is improved by means of that latching configuration.

In accordance with still a further aspect of the invention the screw connection is in the form of a knurled screw.

The invention also concerns a microphone with a microphone holder as described hereinbefore.

The invention is described hereinafter in greater detail by means of the specific embodiments and the accompanying drawings.

### BRIEF DESCRIPTION OF THE DRAWINGS

FIGS. 1A through 1C show various views of a microphone holder according to the present invention; and

FIGS. 2A through 2C each show various views of a microphone holder in accordance with the present invention.

### DESCRIPTION OF THE PREFERRED EMBODIMENTS

The microphone holders shown in the Figures serve for fixing microphones for example to drums, in particular of percussion instruments.

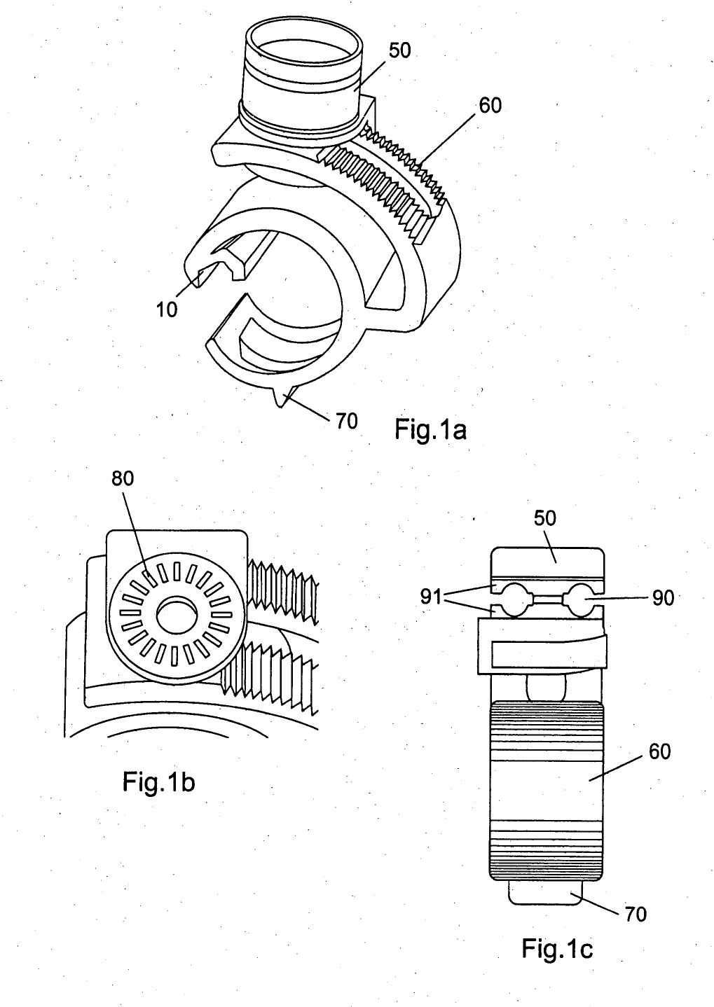

FIG. 1A shows a perspective view of a microphone holder according to the present invention. In this case the microphone holder substantially comprises a holding portion 60, 50 and a clamping or fixing portion 10. In this case the clamping portion 10 substantially comprises two arms which extend in a substantially arcuate configuration. The holding portion 60 is also of a substantially arcuate configuration and is also arranged at a spacing from the clamping portion. Fixed to the holding portion 60 is a holding means 50 which serves to receive the microphone. A latching configuration 61 is provided along the holding portion to improve the adjustability or arresting of the holding means 50 along the holding portion. The holding means is connected to the arcuate holding portion by means of a knurled screw 50.

FIG. 1B shows a detail view of the microphone holder of FIG. 1A. Here in particular the lower part of the holding means (that is to say without the knurled screw) is shown. The lower region of the holding means, like the holding portion, also has a latching configuration 80 which is intended to improve the adjustability or arresting of the adjusting means about its axis of rotation.

FIG. 1C shows a side view of the microphone holder of FIG. 1A. In particular the two holes or openings 90 in the adjusting means are illustrated here. In this case the dimensions of the openings 90 are adapted to the outside diameter of the microphone. A gripping projection 70 is also fixed to an arm of the clamping portion.

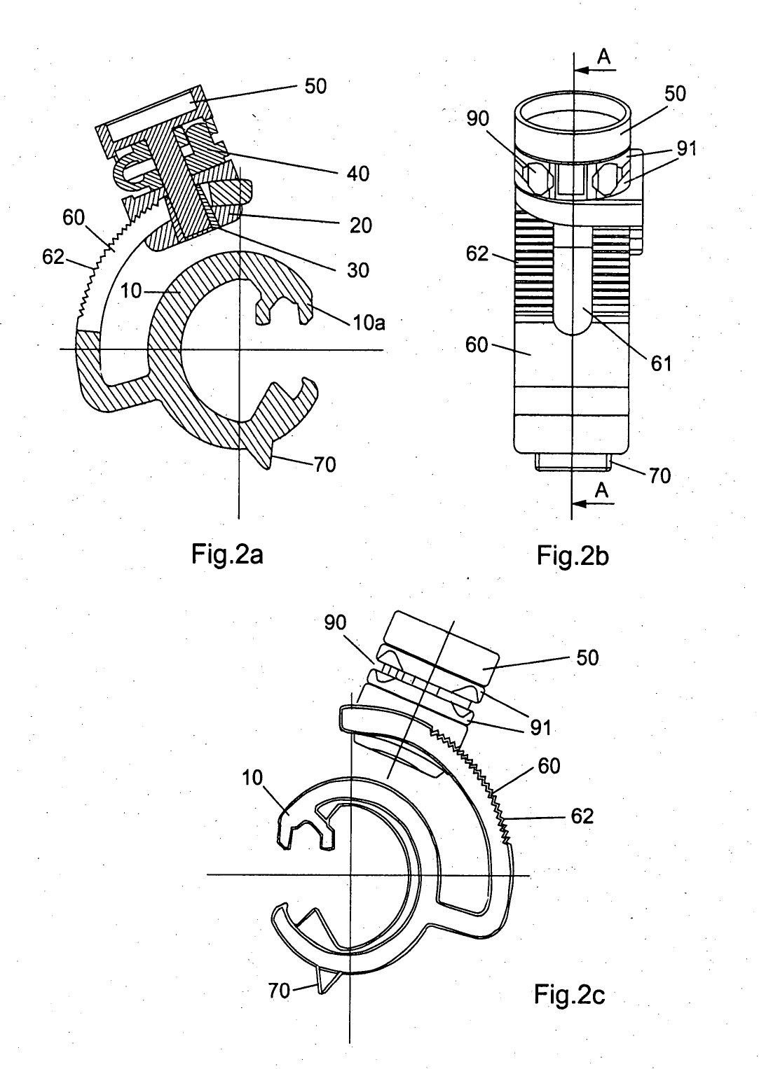

FIG. 2A shows a sectional view of the microphone holder according to the invention. In this case the clamping portion 10 has an arm with a C-shaped end 10a and a second arm having a notch 10b at its end. As already described with reference to FIG. 1A the two arms are of a substantially arcuate configuration. The holding portion 60 is also of a substantially arcuate configuration and has a slot 61 as well as a latching configuration 62 at its outside. The adjusting means is fixed to the arcuate arm of the holding portion or to the slot 61 by means of a knurled screw 50 and a corresponding counterpart portion 30.

FIG. 2B shows a side view of the microphone holder according to the invention. The arcuate arm 60 of the holding portion has a slot 61 and a latching configuration 62. In order to receive a microphone in the holding means, there are provided two clamping disks 91 with a corresponding opening 90. A microphone can be arrested in the opening 90 by means of the knurled screw 50.

FIG. 2C shows a further sectional view of the microphone holder according to the invention. Here, besides the clamping portion 10 and the arcuate arm of the holding portion, the Figure also shows the holding means with the two clamping disks 91 and the knurled screw 50.

The clamping portion 10 serves in this case for fixing the microphone holder for example to a percussion instrument. In this case the clamping portion 10 can be made for example from Hytrel or a thermoplastic elastomer. The configuration of the two ends 10a and 10b of the two arms of the clamping portion 10 is in this case preferably such that the clamping portion 10 can be fixed to a tensioning hoop of a drum.

In this case the openings 90 are of such a configuration that they can receive a swan-neck of a swan-neck microphone. The holding means with a swan-neck microphone can be displaced along the slot 61 by releasing the knurled screw 50.

The two clamping disks 91 are preferably made from elastomer so that they hold a swan-neck of a swan-neck microphone by way of friction and at the same time protect the surface thereof. Preferably the clamping disks are connected together and produced in one tool.

By releasing the knurled screw 50, a swan-neck microphone arranged in the openings 90 can be adjusted in three ways. Firstly, the holding means with the knurled screw and the clamping disks 91 can be moved or displaced along the slot 61 on the arcuate arm 60. The latching configuration on the outside of the arcuate arm 60 serves for simplified arresting of the adjusting means. In addition, the swan-neck microphone can be rotated through 360° about the axis of the knurled screw 50, that is to say the microphone arm can be rotated tangentially with respect to the drum. A latching configuration 80 is also provided here for improving the arresting action. Furthermore, a swan-neck of the swan-neck microphone can be displaced through the openings 90 so that the actually used length of the swan-neck can be suitably adjusted. In that way the microphone can be adjusted either directly on the tensioning hoop of the drum or in the center of the drum.

The fixing clip can be made for example from hard plastic material and the knurled screw 50 can be made from aluminum while the corresponding screwthreaded bush can be made from CuZn.

The clamping portion 10 and the arcuate arm of the holding portion can be made in this case in one piece as an injection molding.

The use of the knurled screw 50 and the corresponding screwthreaded bush 20 provides on the one hand that the microphone is held in the holding means and on the other adjustment of the holding means along the slot 61 is possible.

Although only a swan-neck microphone has been described in the foregoing embodiment, it will be appreciated that other microphones can also be fixed in the openings 90.

Furthermore, rapid fitment to and removal from a percussion instrument can be achieved by the arrangement of the clamping portion with its first and second substantially arcuate arms.

While the foregoing description and drawings represent the present invention, it will be obvious to those skilled in the art that various changes may be made therein without departing from the true spirit and scope of the present invention.

What is claimed is:

1-7. (canceled)

8. A microphone holder for fixing at least one microphone having a microphone housing comprising:
a holding portion having a holding means for holding a microphone; and
a clamping portion for fixing the microphone;
said holding portion including adjusting means for adjusting the holding means along the holding portion;
said holding portion being of a substantially arcuate configuration; and
said adjusting means being in the form of a screw connection for clamping the microphone housing fast in the adjusting means and for securing the adjusting means to the arcuate holding portion.

9. The microphone holder as set forth in claim 8 wherein the holding portion has a slot.

10. The microphone holder as set forth in claim 8 wherein the holding portion has at least portion-wise a latching configuration on the arcuate holding portion.

11. The microphone holder as set forth in claim 8 wherein the screw connection is in the form of a knurled screw.

12. A microphone having a microphone holder as in claim 8.

13. The microphone as set forth in claim 12 wherein the microphone is in the form of a swan-neck microphone.
